(19) United States
(12) Patent Application Publication
(10) Pub. No.: US 2003/0025957 A1
(43) Pub. Date: Feb. 6, 2003

(54) Low cost, all electronic and unobtrusive method of implementing a wavelength supervisory channel for the control and management of individual and multiple wavelengths in an optical communication system

(76) Inventor: Anthony Jayakumar, Bridgewater, NJ (US)

Correspondence Address: Anthony Jayakumar, 2 Powelson Lane, Bridgewater, NJ, 08807, US

(21) Appl. No.: 10/200,960

(22) Filed: Jul. 23, 2002

Related U.S. Application Data
(60) Provisional application No. 60/307,521, filed on Jul. 24, 2001.

(51) Int. Cl. H04B 10/08; H04J 14/02

(52) U.S. Cl. 359/110; 359/133

(57) ABSTRACT

The wavelength supervisory channel is a mechanism for transmitting and receiving control and management information about the wavelength in a multi-wavelength communication system. A plurality of these channels, each being carried on their respective wavelengths can enable a redundant, robust and fault tolerant method of transmitting and receiving the aforementioned control information for the entire communications network comprised of many such optical devices replacing the traditional and more expensive optical supervisory channel or digital wrapper techniques. The invention described below details one embodiment of the wavelength supervisory channel implemented as a sub-carrier modulated orthogonal channel, riding along with the main payload data channel, in an all-electronic, low cost and unobtrusive methodology.

### CROSS REFERENCE

A related provisional patent, entitled“Wavelength supervisory channel for the control and management of individual and composite wavelengths in a multi-wavelength, optical communication system and its implementation by a low cost, all electronic method”—60/307,521 was filed on 7/24/2001.

### FIELD OF THE INVENTION

This invention relates generally to multi-wavelength optical communication systems and more specifically to the control and management of such systems using sub-carrier based in-band signaling.

### DESCRIPTION AND LIMITATIONS OF PRIOR ART

In multi-wavelength optical communications systems, such as Wavelength Division Multiplexing (WDM), Dense Wavelength Division Multiplexing (DWDM) and Coarse Wavelength Division Multiplexing (CWDM) systems, data are transmitted over different wavelengths of light on a single fiber. Due to the wave nature of light these wavelengths art transparent to each other and can be used to carry data in different formats and bit rates and can be dropped off and added at different points in the fiber using, proper optical components.

As the demand for bandwidth increases, these WDM and DWDM systems, once used only in the long haul, backbone networks of national and international telecommunications carriers, are now being widely deployed in short haul metro networks, Cable TV (CATV) fiber-coax hybrid systems, Metropolitan Area Networks (MAN) and in some cases even in inter-campus Local Area Networks (LAN). These short reach WDM, DWDM and CWDM networks typically have the following characteristics:

1) Wavelengths have to be dropped off and added more frequently and within smaller spans.

2) The networks have to support a multitude of topologies such as ring, star, point-to-point, mesh and a combination of all of these.

3) The networks have to operate with multiple data rates, formats and protocols.

4) The networks have to interoperate with equipment from different vendors.

5) The networks have to be lower cost than conventional long haul networks without compromising performance.

6) These networks should be easy to install, operate, manage and trouble shoot.

The above characteristics of the metro access multiple wavelength systems bring a unique set of requirements for effective control of the wavelengths as it traverses through the network. Conventional method of control and management of a multi-wavelength system involves the use of a dedicated channel or wavelength; usually well above or below the band of wavelengths used to carry traffic. This dedicated channel usually called the Optical Supervisory Channel (OSC) rides with the payload channels in the fiber and gets dropped off and added at all the nodes in the network. All the network elements at the nodes can communicate with each other using common communication protocols using this OSC. This approach has the following disadvantages:

7) This is an expensive approach due to the cost of the optical components that are requited to set up the dedicated wavelength. The optical component costs are far more dominant than any electrical or mechanical component costs in an optical network element.

8) It is an inefficient use of the available bandwidth of the channel as the control and management information rate is far lower than the information carrying capacity of the channel. Network operators would rather carry significant revenue generating payload in that channel if they could.

9) As the entire operations, management and control information is carried in the OSC, there is a significant risk of losing control over the network if the OSC is compromised.

10)The OSC is more suited to the ring topology due to the inherent redundancy provided by the rings. It is prohibitively expensive in point-to-point or star topologies.

11)The OSC is prohibitively expensive in situations where a small number of wavelengths are used. This could happen as network operators start out with a few wavelengths in the network and then add channels as the demand for bandwidth increases.

12)Since the OSC is carrying control, management, status and other operational information about the entire set of wavelengths in the network, complex routing and switching methodologies have to be used to ensure that the correct information is conveyed to and from each of the wavelength management systems in the network.

In contrast to the OSC methodology, a technique called the “Digital Wrapper” is sometimes used to send control, management, status, routing and other operational messages to manage the individual wavelengths or channels in a multi-wavelength system. This consists of taking the payload data bit-stream, along with its framing protocol and wrapping a header and trailer data that contain the control and management messages for that wavelength. At the receiver, the bit stream is examined and the header and trailer data are then “unwrapped” and the control and management messages are retrieved. The payload data is then reassembled and sent forth or de-multiplexed and routed at that node. This methodology has the following disadvantages:

13) This is an expensive and cumbersome approach since the header and trailer information have to be wrapped to high-speed payload data streams.

14)The payload data can be as high as 2.5or 10 Gb/s per second (2.5 or 10 billion bits per second) and to wrap the header and trailer data packets, as well as unwrap these header and trailer at the receiver at this high speed involves complex, high speed and expensive electronic circuitry.

15)This technique is applicable to only specific data protocols and formats such as SONET or Gigabit Ethernet as the complex wrapping and unwrapping circuitry can only be made to operate on a small number of such popular, predefined data Protocols.

16)When the date bit-streams are digitally wrapped with the header and trailer information, their bit-rates then become non-standard and this precludes the use of conventional transmission equipment. Expensive multi-rate transmission equipment has to be used.

A third method of transmitting control and management information over a single or multi-wavelength optical is the use of a sub-carrier modulated transmission channel that is superimposed on the base-band optical channel as described by Fee in U.S. Pat. Nos. 5,995,256 and 6,108,113 and Chang et al. in U.S. Pat. No. 6,160,651. These methods do address the shortcomings of the OSC and the Digital Wrapper methodologies described above. However, the sub-carrier modulated transmission method described by Fee et al. in U.S. Pat. Nos. 5,995,256 and 6,108,113 suffers from poor Signal to Noise Ratio (SNR) of the sub-carrier signal when recovered by the sub-carrier receiver. One reason for the poor SNR is due to the use of an optical tap to separate the two signals—the loss introduced by the optical tap reduces the total signal available for detection by the receiver. In addition, the sub-carrier signal relies on the main channel optical receiver for the detection of the modulated sub-carrier signal. Since the main channel optical receiver is a broadband receiver, tuned to receive the high-speed base-band signal, the noise introduced by this broadband receiver greatly reduces the SNR. Moreover, the optical tap introduces a loss in receiver sensitivity for the main receiver, which, in most cases, is not acceptable. The method described by Fee in U.S. Pat. Nos. 5,995,256 tries to overcome the limitation of low SNR by passing the same sub-carrier signal in all the wavelengths in a multi-wavelength system and summing the sub-carrier signals at the far end using multiple parallel receivers. Unfortunately, this scheme does not work for single wavelength systems and it requires costly, multiple receivers and optical signal taps for extracting the sub-carrier signal. In addition, only one sub-carrier channel is available in a multi-wavelength system and this does not allow for individual channel control and management in such systems. For these reasons the method described by Fee in U.S. Pat. Nos. 5,995,256 and 6,108,113 is not widely used or implemented.

The method introduced by Chang et al. in U.S. Pat. No. 6,160,651 describes a sub-carrier modulation system that is modulated at frequencies that are higher than the bandwidth of the baseband signal. For 2.5 Gb/s or 10 Gb/s base-band signals, this implies that the sub-carrier will be around 4-5 GHz and 12-14 GHz respectively). This method will lead to higher sub-carrier channel bandwidth and data-rate but at a hugs increase in complexity, power consumption, cost and other technological hurdles. This method is certainly not suitable for low cost metro applications. In addition, this method is still susceptible to the low SNB effect described in the previous paragraph.

These and other shortcomings and limitations of the prior art are obviated with the present invention. As multi-wavelength communications systems start being widely deployed in cost sensitive metro access, CATV hybrid fiber-coax, MAN and LAN networks, it is imperative that the cost of deployment, operation, management, provisioning and switching of here networks be dramatically reduced. The present invention which embodies a methodology and concomitant circuitry described blow, promises to radically reduce this cost by implementing the control and management functions for each wavelength by an all electronic circuitry while at the same time providing a robust, fault tolerant and simpler control and supervisory methodology.

### SUMMARY OF THE INVENTION

Briefly stated, the invention shows a method of multiplexing a low frequency (5-65 MHz) sub-carrier which is modulated with the control, management, routing, switching and other pertinent information that relates to the wavelength on which the carrier is transmitted along, with the high-speed main payload data that is transmitted on that wavelength.

On the transmit side, the sub-carrier modulation is injected in the DC bias port of the laser diode. The advantages of this method are:

17)The signal bandwidth of this port is typically less than 100 MHz for standard packaged DFB lasers and hence the sub-carrier signal can be coupled effectively to the laser.

18)The critical RF nodes in the main channel are not affected by this approach and hence this is a non-intrusive method of injecting the sub-carrier signal.

19)It is electronically feasible to enable the modulation index of the injected sub-carrier signal track the temperature/bias current and aging/bias current characteristics of the laser diode so that the sub-carrier modulation index stays constant over the operating temperature and lifetime of the laser.

On the receive side, there are two trans-impedance amplifiers connected to the APD or the PIN detector. The transmitted signal causes photocurrent that corresponds to the modulated sub-carrier to be excited on the APD or PIN detector in addition to the photocurrent that is generated due to the payload data traffic. One trans-impedance amplifier is the conventional broadband amplifier and is used to recover the high-speed pay load traffic. The second amplifier is a narrowband trans-impedance amplifier that is tuned to receive the modulated sub-carrier containing the control and management information. This current is sensed and amplified by the tuned trans-impedance amplifier. The signal is then demodulated and the data is received at the receiver.

The advantage of the second narrowband trans-impedance amplifier is that it can be tuned and optimized to receive the modulated sub-carrier. This method preserves the high signal to noise ratio inherent in the signal transmitted through the optical medium. The input to this narrowband transimpedance amplifier is taken from the terminal of the photo-detector that is normally connected to the ground or other low impedance nodes in the receiver. This confers the following benefits:

20)The main channel receiver is not affected and hence no bandwidth or cost penalties are assumed.

21)There is no need to use any optical taps and this preserves the main and sub-carrier channel receiver sensitivities

22)The preservation of main and sub-carrier channel receiver sensitivities due to the benefits listed in 21) above, enables the use of a lower modulation index on the sub-carrier which results in negligible main channel receiver sensitivity penalty due to sub-carrier modulation.

23)This is minimally invasive procedure. Access to the critical internal nodes of the receiver is not required and the input to the tuned narrowband trans-impedance amplifier can be taken from the AC ground lead of the PIN or APD photo-detector.

The transmission channel created by this sub-carrier is designated as the Wavelength Supervisory Channel (WSC). The WSC can be used to carry the information that is pertinent to its wavelength. Such information could include: control, management, routing, switching, status, performance monitoring, security codes, encryption keys, and so on. The advantages of this invention over prior art are summarized below:

24)The carrier modulation at the transmitter and the signal detection at the receiver are performed by purely in the electronic domain by low cost electronic components. Hence this method is very inexpensive to implement.

25)There are no additional optical components like filters, taps, lasers or photo-detectors, to implement the WSC, This translates into large reduction in the implementation cost since the cost is dominated by optical components.

26)Due to the benefit listed in 25) there is also a savings in space and power consumed by the transmission system. This translates to additional savings in cost for the overall system.

27)The carrier modulation frequency is chosen to be 5-65 MHz. This enables the low-cost electronic components such as the digital modulators and demodulators that have been developed for the cable modem industry to be used in this application. Widely used, readily available, very well understood and very low cost electronic components can be used to build this system.

28)The carrier modulation frequency, chosen to be between 5-65 MHz, occupies a tiny sliver of the broadband optical channel bandwidth. This implies that there is minimal change to existing transmitter and receivers. The above circuitry can be implemented in a “daughter” card and plugged into existing transmitters and receivers with very little modification.

29)The modulation depth of the WSC carrier can be kept below 3% of that of the payload channel modulation and this introduces minimal “eye” degradation at the transmitter and sensitivity penalty for the main payload receiver.

30)The use of a tuned narrow-band receiver for the sub-carrier preserves the high SNR inherent in optical transmission systems.

31)Since there is no optical tap at the receiver there is no loss of optical signal and hence no loss in the receiver sensitivity for the broadband payload data except due to the minimal degradation caused by benefit listed in 29).

Additional technical advantages should be readily apparent to those skilled in the art from the drawings, description and the claims.

### BRIEF DESCRIPTION OF THE DRAWINGS

For a more complete understanding of the present invention and the advantages that it confers over prior art, the following detailed description should be taken in conjunction with the accompanying drawings in which like reference numerals indicate like features and wherein:

FIG. 1 is a block diagram of one embodiment of a multi-wavelength optical communications system using optical amplification, with one wavelength dedicated as the optical supervisory channel;

FIG. 2 is a block diagram of one embodiment of a multi-wavelength optical communications system using optical amplification, with the optical supervisory channel replaced by a plurality )f wavelength supervisory channels each enabled by a plurality of sub-carriers, each transmitted along with payload data according to the present invention;

FIG. 3 is a block diagram of one embodiment of the transmitter according to the present invention;

FIG. 4 is a block diagram of one embodiment of the receiver according to the present invention;

FIG. 5 is a detailed schematic diagram of one embodiment of the transmitter according to the present invention;

FIG. 6 is a detailed schematic diagram of one embodiment of the receiver according to the present invention;

FIG. 7 is a detailed block diagram of one embodiment of the transmitter and receiver using a locally generated carrier at both the transmitter and receiver according to the present invention;

FIG. 8 is a detailed block diagram of one embodiment of the transmitter and receiver using a carrier that is generated with the aid of payload data clock at both the transmitter and receive,, according to the present invention;

FIG. 9A expresses, in a graphical plot, the effect of sub-carrier modulation on the receiver sensitivity of the main channel, in this case an SONET OC-48 transmission system operating at 2.488 Gb/s, for various sub-carrier modulation indices.

FIG. 9B expresses, in a graphical plot, the receiver sensitivity of the sub carrier channel operating at 1 Mb/s with no Forward Error Correction (FEC), of the same SONET OC-48 transmission system operating at 2.488 Gb/s, for various sub-carrier modulation indices.

### DETAILED DESCRIPTION OF THE INVENTION

The wavelength supervisory channel (WSC) is a mechanism for transmitting and receiving control and management information about the wavelength in a multi-wavelength communication system. A plurality of these channels, each being carried on their respective wavelengths can enable a redundant, robust and fault tolerant method of transmitting and receiving the aforementioned control information for the entire communications network comprised of many such optical devices replacing the traditional and more expensive optical supervisory channel or digital wrapper techniques. The invention described below details one embodiment of the wavelength supervisory channel implemented as a sub-carrier modulated orthogonal channel, riding along with the main payload data channel, in an all-electronic, low cost methodology.

Specifically, the present invention provides a method for transmitting the control information by modulating a carrier between the frequency range of 5-65 MHz with the aforementioned control information, by common modulation methods such as frequency shift keying (FSK), phase shift keying (PSK), quadrature phase shift keying (QPSK), differential quadrature phase shift keying (DQPSK) or quadrature amplitude modulation (QAM). The laser is simultaneously modulated with the payload data on the main radio frequency (RF) modulation port and sub-carrier modulated on the DC bias port. Error correction algorithms such as Reed-Solomon coding can be used to increase the robustness of the transmission. At the receiver, the invention provides a method of recovering the control information present in the carrier using a narrowband trans-impedance amplifier tuned to the specific carrier frequency while at the same time, recovering the broadband payload data without any aberration. If error correction coding is used in the transmitter, error correction decoding is performed in the receiver to recover the control information. Moreover, the carrier frequency at the transmitter can be derived from the underlying clock of the payload data channel aid this enables the receiver to use the recovered clock from the payload data to recover the carrier frequency bestowing great simplification of the carrier frequency recovery process. The carrier frequency can be uniquely chosen for each of the different wavelengths in the system and this frequency can still be derived from the underlying payload data clock, irrespective of the bit-rate of the payload data, using sophisticated direct digital synthesis techniques. This enables the modulated carrier to act as a simple wavelength or channel power monitor in addition to providing a communication channel for control and supervisory information.

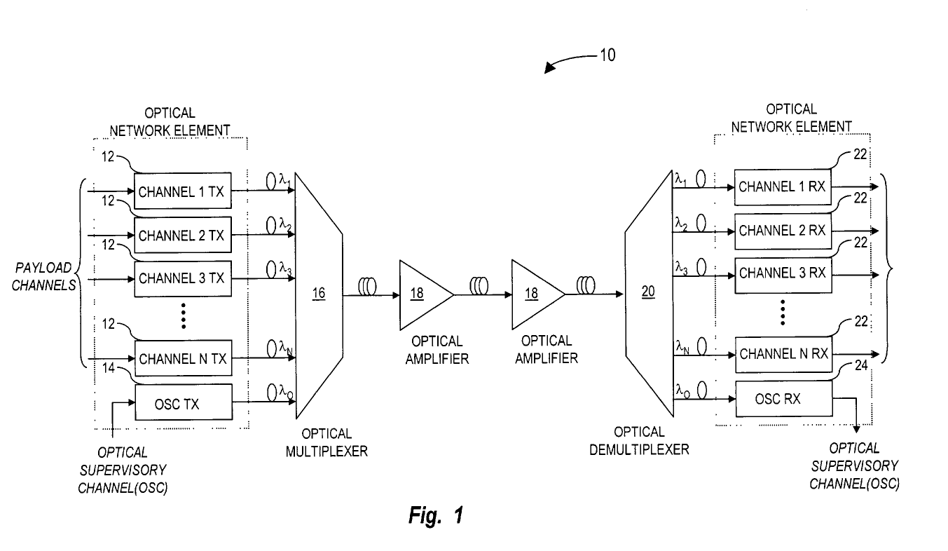

FIG. 1 is a block diagram of one embodiment of a multi-wavelength optical communication system, indicated generally by the numeral 10. The system 10 consists of N optical transmitters 12 transmitting payload data, each operating at a different optical wavelength λₗ through λ_{N}, and their outputs are combined by the optical multiplexer 16 onto a single optical fiber. There is a unique transmitter 14 that is designated as the optical supervisory channel (OSC) to carry the control and management information associated with all the wavelengths on the fiber on a separate wavelength λ_{O}. The combined optical signals from the output of the multiplexer 16 may be amplified by optical amplifier 18 to compensate for signal loss due to distance transmission as well as for other factors. A transmission span might contain one or a plurality of optical amplifiers. At the receiving node, the different wavelengths, λₗ through λ_{N}, are separated by the optical de-multiplexer 20 and hie separated wavelengths are fed into their respective receivers 22. The optical supervisory channel is also de-multiplexed and fed to the receiver 24 where the control and management information is retrieved and used at the receiving station.

There are a number of disadvantages to this method of control and management of the wavelengths in an optical network. They all relate to the cost and complexity of the equipment involved. To reiterate: This is an expensive approach due to the cost of the optical components in 14 and 24 that are required to set up the dedicated wavelength. The optical component costs are far more dominant than any electrical or mechanical component costs in an optical network element. It is also an inefficient use of the available bandwidth of the channel offered by wavelength λₗ, as the control and management information rate is far lower than the information carrying capacity of the channel. Network operators would rather carry significant revenue generating payload in that channel if they could. In addition, the OSC is prohibitively expensive in situations where a small number of wavelengths are used. This could happen as network operators .tart out with a few wavelengths in a network and then add channels as the demand for bandwidth increases. Furthermore, the OSC is more suited to the ring topology due to the inherent redundancy provided by the rings. It is prohibitively expensive in point-to-point or star topologies as this redundancy factor is absent in these topologies. In addition, as the entire operations, management and control information is carried in the OSC; there is a significant risk of losing control over the network if the OSC is compromised. Since the OSC is carrying control, management, status and other operational information about the entire set of wavelengths in the network, complex routing and switching methodologies have to be used to ensure that the correct information is conveyed to aid from each of the wavelength management systems in the network. Finally, the OSC is a cumbersome and expensive approach in metro and dense short haul networks where there is a plurality of connection topologies such as ring, point-to-point, mesh etc.

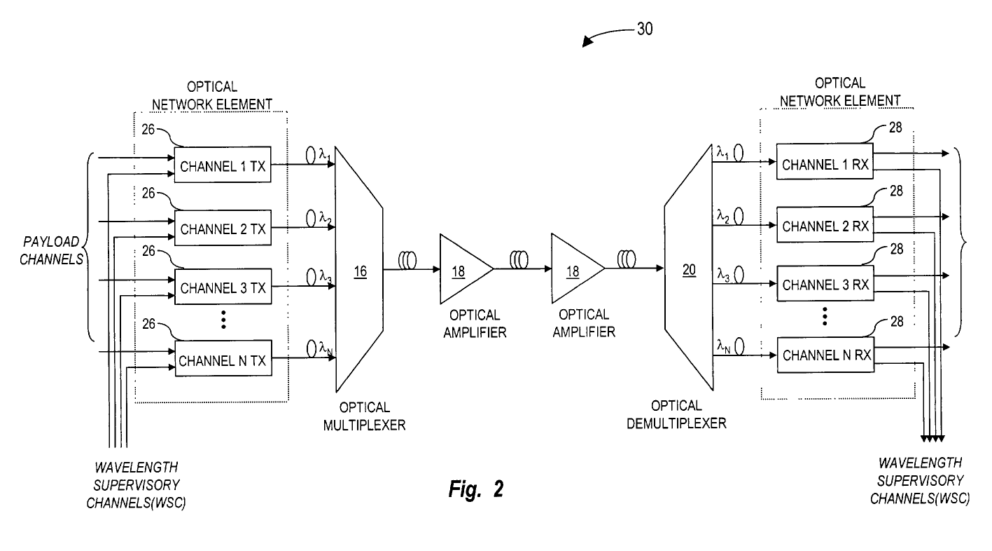

FIG. 2 Is a block diagram of an alternate embodiment of the multi-wavelength optical communications system, indicated generally by the numeral 30, using the present invention. As evident from the drawings, the system 30 is similar to the system 10 shown in FIG. 1. However, the OSC transmitter 14 and receiver 24 have been eliminated. The control and management information that is relevant to each wavelength is separately modulated by a sub-carrier at each transmitter 26 and received at each receiver 28 along with the payload data for each of those channels.

The alternate embodiment of 30 using the present invention makes use of a very narrow sliver of bandwidth in the payload data channel to transmit and receive wavelength specific control and management information. This narrowband channel is designated as Wavelength Supervisor; Channel (WSC). The WSC originates and terminates along with the underlying mg data channel.

The system embodiment of 30 alleviates all of the aforementioned disadvantages of the system embodiment of 10. The WSC carrier modulation at the transmitter and the signal detection at the receiver are performed by purely in the electronic domain by low cost electronic components. Hence this method is very inexpensive to implement. There are no additional optical components like filters, taps, lasers or photo-detectors, to implement the control and management channel. This results in savings in space and power consumed by the transmission system. This translates to additional savings in cost for the overall system. Furthermore, there are no optical taps on the receiver to recover the modulated carrier. This reduces the cost as the signal tapping is done purely in an electronic manner. As a result, there is no loss of optical signal and hence no loss in the receiver sensitivity for the broadband payload data except due to the minimal degradation caused by eye distortion due to the modulation of the WSC carrier. As an added benefit, the multiple WSCs in a single fiber provides a reliable, redundant and Fault tolerant control and management communication channel for the entire network. In addition, it is well suited to a wide variety of network topologies found in metro and dense short haul networks since the WSC rides along with the payload data in a point-to-point manner. Finally, it provides for graceful upgrade of dense metro networks since the WSC can be added on a per wavelength basis.

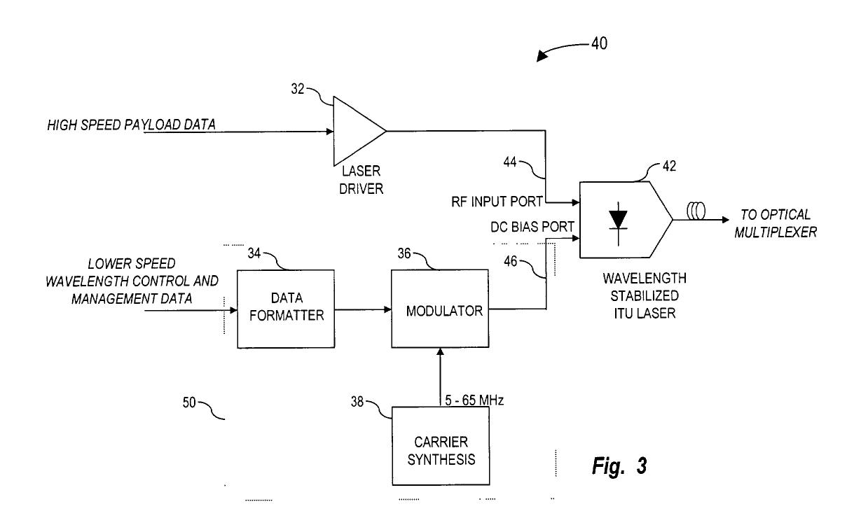

FIG. 3 is a block diagram of one embodiment of the transmitter 26, of the present invention. The diagram shows only the relevant portions of the transmitter, indicated generally by 40, that is necessary for the understanding of the operation of the invention. Transmitter 26 will contain other functions and components that are necessary for its operation that is not described in this document. The system indicated by 40 consists of a laser driver 32 that modulates the laser 42 with the broadband, payload data, which is usually in the Non-Return to Zero (NRZ) format. The laser is modulated through the main RF port, indicated by 44; of the laser. The payload data is usually a high-speed bit-stream that fully utilizes the bandwidth capacity of the laser driver 32, the RF modulation port 44 and the laser 42. To enable the WSC, the present invention incorporates the system indicated by 50 into the embodiment of 40. The control and management information that has to be modulated on to the WSC is processed in the data formatter 34. In the formatter, the data is assembled into packets with header and trailer information and coded for error correction and transmission. The formatted data is then fed to the modulator 36 where it is filtered, up-converted on to the sub-carrier and amplified or attenuated to the required output level. The modulator can be either analog or digital. The modulated carrier is then input to the DC bias port of the laser 46. Thus both the high bit-rate payload data and the relatively low frequency WSC carrier can be simultaneously modulated by the laser and transmitted over the multi-wavelength optical communication system.

The carrier frequency is generated by the clock synthesis system indicated by 38. Each distinct wavelength in the communication system can be assigned a unique carrier frequency, which can be used for wavelength identification purposes. The carrier frequency can be generated at each transmitter with a crystal oscillator and each WSC operating with a set offset in frequency from each other using pre-scalers with slight offsets in divide ratio or using direct digital frequency synthesis techniques. Although quite straightforward in the transmitter, this approach requires that the carrier be recovered at the receiver for each of the WSC channels, complicating th design of the receiver. An alternate approach is to use the clock of the underlying payload data channel to derive the carrier frequency. Since the transmit clock of the payload data is recovered at the receiver, it is advantageous to use this common synchronous clock to generate the WSC carrier at both the transmitter and receiver.

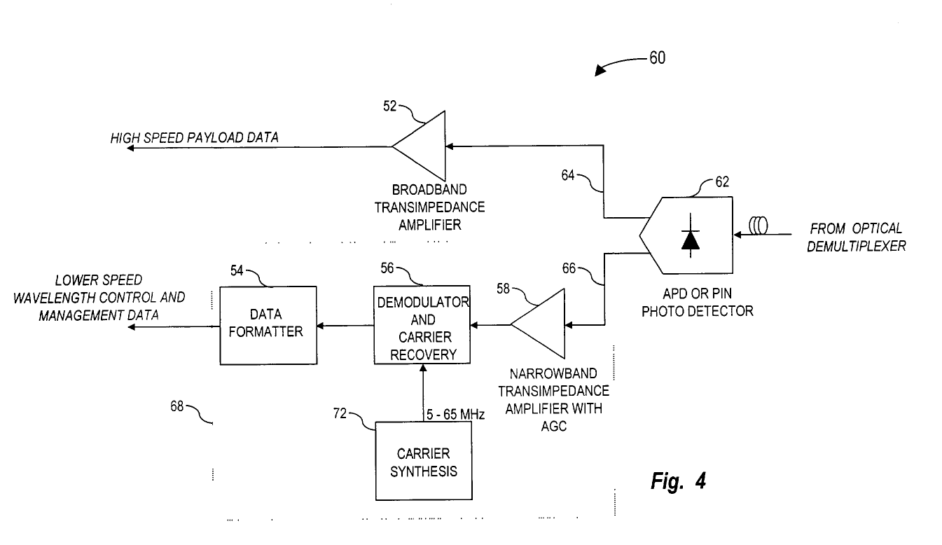

FIG. 4 is a block diagram of One embodiment of the receiver 28, of the present invention. The diagram shows only be relevant portions of the receiver, indicated generally by 60, that is necessary for the understanding of the operation of the invention. Receiver 28 will contain other functions and components that are necessary for its operation tat is not described in this document. The system indicated by 60 consists of a PIN or APD photo-detector 62 that converts the incident light pulses into photocurrent pulses. Normally, this photocurrent pulses are then fed into a broadband trans-impedance amplifier 52 that has enough bandwidth to convert them into amplified voltage pulses. Voltage amplification, clock recovery, data decision and re-clocking are then performed to recover the high bit-rate, broadband, payload data.

To enable the WSC, the present invention incorporates the system indicated by 68 into the embodiment of 60. A narrow band trans-impedance amplifier, tuned to the WSC sub-carrier is placed in the receiver photocurrent path. Persons skilled in the art can envision many different ways of doing this. The carrier voltage is recovered, amplified or attenuated by an automatic gain control circuitry within the amplifier and fed into the demodulator 56 where the signal is down-converted, filtered and the base-band WSC data is recovered. The demodulator can recover the carrier if it was derived independently of the underlying data channel clock in the transmitter with additional circuitry. But if on the other hand, if the carrier was derived from the payload data channel transmit clock at the transmitter, then it can be generated locally at the receiver in a similar manner from the recovered payload data clock. This enables the reuse of the same circuitry 38, 72 for carrier synthesis at both the transmitter and receiver. The base-band data is fed into the data formatter 54 where it is decoded, error corrected and the header and trailer information stripped and the WSC control and management information retrieved and used at the receiving station.

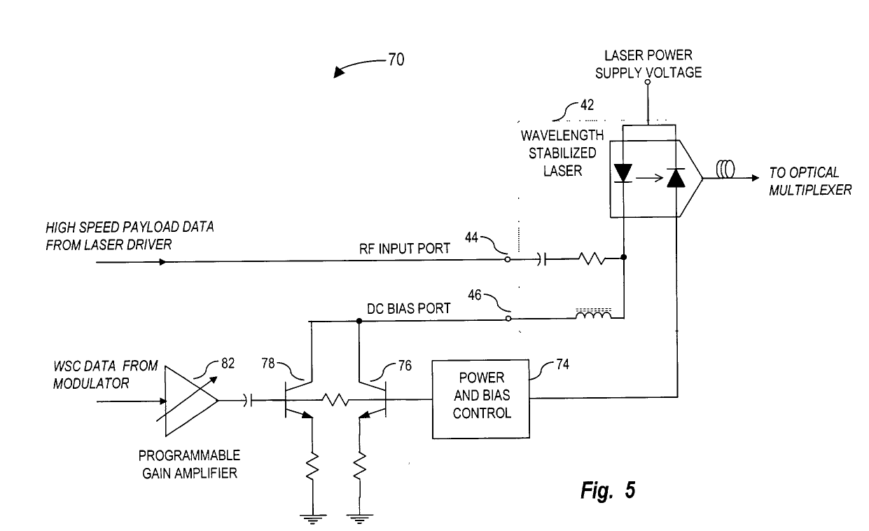

FIG. 5 is a detailed schematic diagram of one embodiment of the modulation portion of the transmitter 40, indicated generally by 70, according to the present invention. The schematic is not intended to be a complete design document but to convey the overall concept. The laser module 42 typically consist of a mechanism for keeping its temperature and hence its wavelength constant, a PIN detector to control the output of the laser in conjunction with external circuitry 74, a RF modulation port 44 for modulation of high speed payload data, and a DC bias Snort 46 for providing a DC bias current for the laser. The DC bias port 46 is primarily used to provide a constant DC current through the laser to set its operating bias point end is designed to block thigh frequency AC signers. Since the WSC carrier band is restricted to a relatively low range in frequency, typically between 5-65 MHz and also since only low levels of modulation (1-3% of average transmitted optical power) are used, it is possible to use the DC port to modulate the WSC carrier onto the laser. Electronic circuitry in the power and bias control circuitry subsystem 74 ensures that the output power and modulation level are constant over all operating temperatures and over the lifetime of the laser. The laser has and power control current is carried by the transistor 76. In the embodiment of this invention, an additional transistor 73 is used to carry a small fraction equal to the maximum modulation factor, of this current, typically 3% of the total current that is carried transistor 76. The WSC modulated carrier is AC coupled to the base of this transistor through a programmable gain amplifier 82. The modulation factor of the WSC carrier can be set to the desired value by programming the proper gain or attenuation of this amplifier. Some laser drivers provide an auxiliary modulation port, which could be also used to modulate the WSC carrier. Persons skilled in the art can devise numerous modifications and variations to specific aspects of the above embodiment without departing from the scope of the present invention.

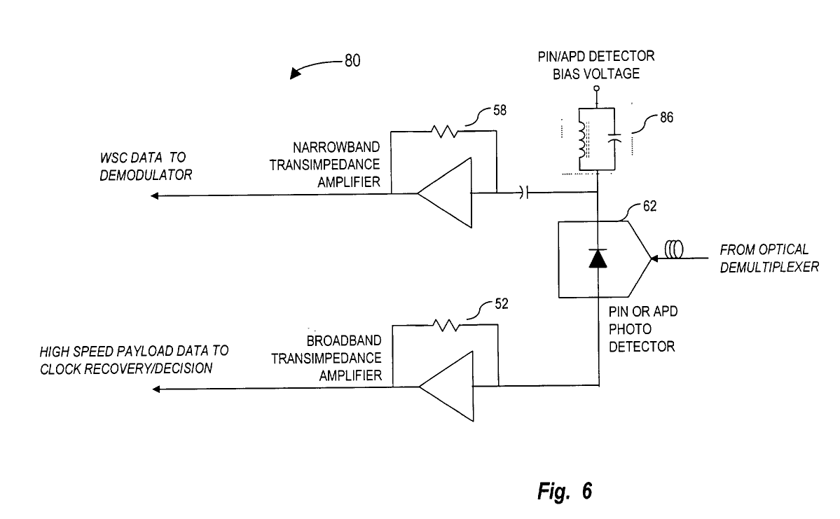

FIG. 6 is a detailed schematic diagram of one embodiment of the WSC sub-carrier detection portion of the receiver 60, indicated generally by 80, according to the present invention. The schematic is not intended to be a complete design document but to convey the overall concept. The receiver consists of a PIN or an APD photo-detector 62 whose cathode is biased positively with respect to its anode. In the case of PIN detectors, the positive bias on the cathode is generally less than 5 V. However, in the case of higher sensitivity APD detectors, the positive bias can be as high as 50 V. In a standard receiver, the PIN or APD detector anode is connected to a broadband trans-impedance amplifier 52 where the induced photocurrent pulses are converted into voltage pulses. This transimpedance amplifier is designed to have sufficient bandwidth to pass the high bit-rate payload data. The voltage pulses are amplified and clock-recovery/decision/retiming functions are performed. In the embodiment of this invention, a narrowband trans-impedance amplifier 58, tuned to the WSC carrier frequency is connected to the cathode of the detector through a capacitor. The capacitor, in addition to providing an AC path for the WSC sub-carrier photocurrent to the narrowband trans-impedance amplifier 58, isolates the high voltage APD photo-detector cathode from the low voltage inputs of the amplifier. A similar embodiment could also be done with a tuned transformer although the capacitor approach is smaller and less expensive. Furthermore, a parallel resonant circuit 86, resonant a, the WSC carrier frequency, is placed at the cathode of the PIN or APD detector cathode so as to prevent the WSC carrier photocurrent to be dissipated at the detector bias voltage supply. The amplified WSC sub-carrier is filtered and then demodulated in 56. An alternate embodiment of the above principle can use a tuned narrowband voltage amplifier, through a coupling circuit, instead of the tuned trans-impedance amplifier to sense the WSC sub-carrier photocurrent from the cathode of the photo-detector. Persons skilled in the art can devise numerous modifications and variations to specific aspects of the above embodiment without departing from the scope of the present invention.

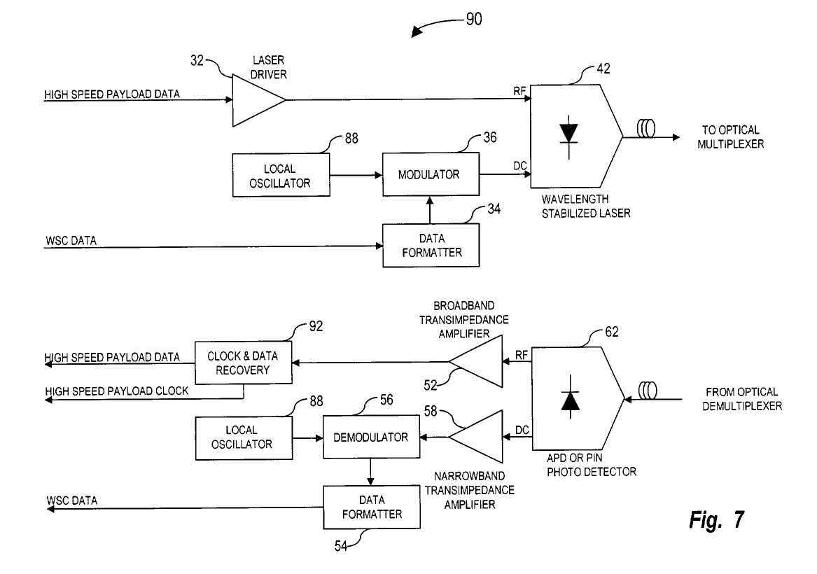

The WSC sub-carrier can be generated locally at the transmitter using a pre-defined frequency plan. This frequency plan can be such that each unique wavelength in the communication system can be defined a unique carrier frequency. This will enable the wavelength identification and measurement of channel power as done in prior art. Hence the modulation of the WSC sub-carrier does not disrupt the conventional pilot tore based wavelength identification and channel power measurement methodology. FIG. 7 shows an embodiment of the complete W SC transmit and receive path with carrier generated locally at the transmitter, indicated generally by 90. Here the local oscillator 88 is used to generate. the sub-carrier. The local oscillator consists of a high precision, crystal oscillator to set the absolute reference timing and the proper carrier frequency is obtained through any one of the following means: 1) a divider chain; 2) a phase locked loop with pre-scaler set to the proper divide ratio; or 3) direct digital frequency synthesis. At the receiver, the carrier reference can be obtained with an identical local oscillator 88, with any residual carrier frequency error between the transmitter and the receiver nulled by electronic circuitry, either analog or digital, in the demodulator 56. The need for carrier recovery adds complexity to the design of the receiver.

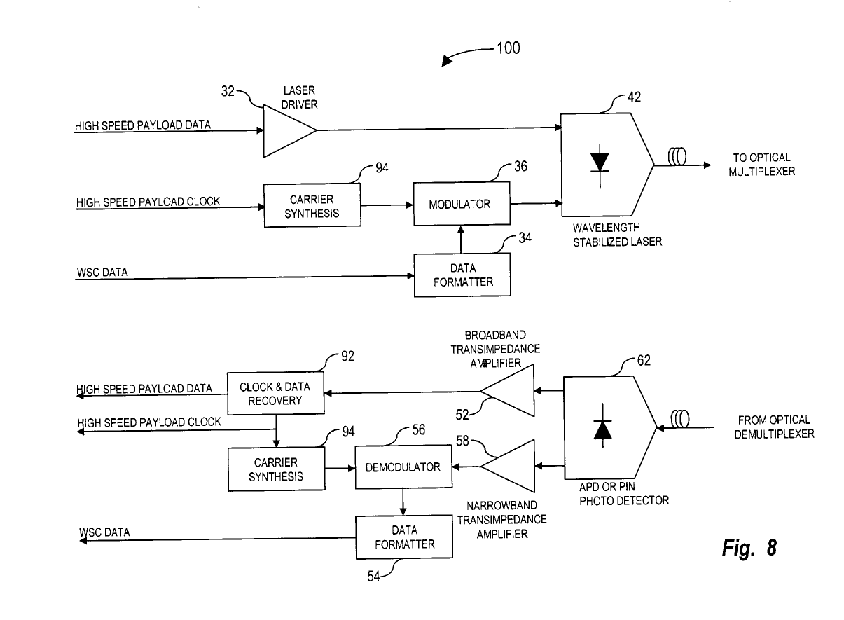

The need for carrier recovery at the receiver can be alleviated by the invention shown in FIG. 8 which shows an embodiment of the complete WSC transmit and receive path indicated generally by 100. Here instead of the local oscillator generating the carrier, the carrier can be generated using the transmit payload data-stream clock. The clocks of the payload data are usually very precise, stable and they are tied to national or global references. At the receivers, the payload data clock is generally recovered from the payload data. Hence there is a clean, precise and stable reference clock available at both the transmitter and the receiver. This payload data clock can be used to generate the WSC carrier frequency. Since the carrier frequency might not be an exact divisor of the payload data clock, a simple divider chain might not be sufficient to generate the carrier, and other methods such as a phase locked loop with pre-scaler set to the proper divide ratio or direct digital frequency synthesis have to be used. As shown in FIG. 8, the high speed transmit clock is used by the carrier synthesis subsystem 94 to generate the WSC carrier in the transmitter. In the receiver, the high speed data clock is recovered by the clock and data recovery subsystem 92. A carrier synthesis subsystem 94, identical to the one used in the transmitter is used to generate the carrier using the recovered payload data clock. This enable synchronous demodulation of the WSC carrier at the receiver, which results in simpler receiver design as well as improved sensitivity.

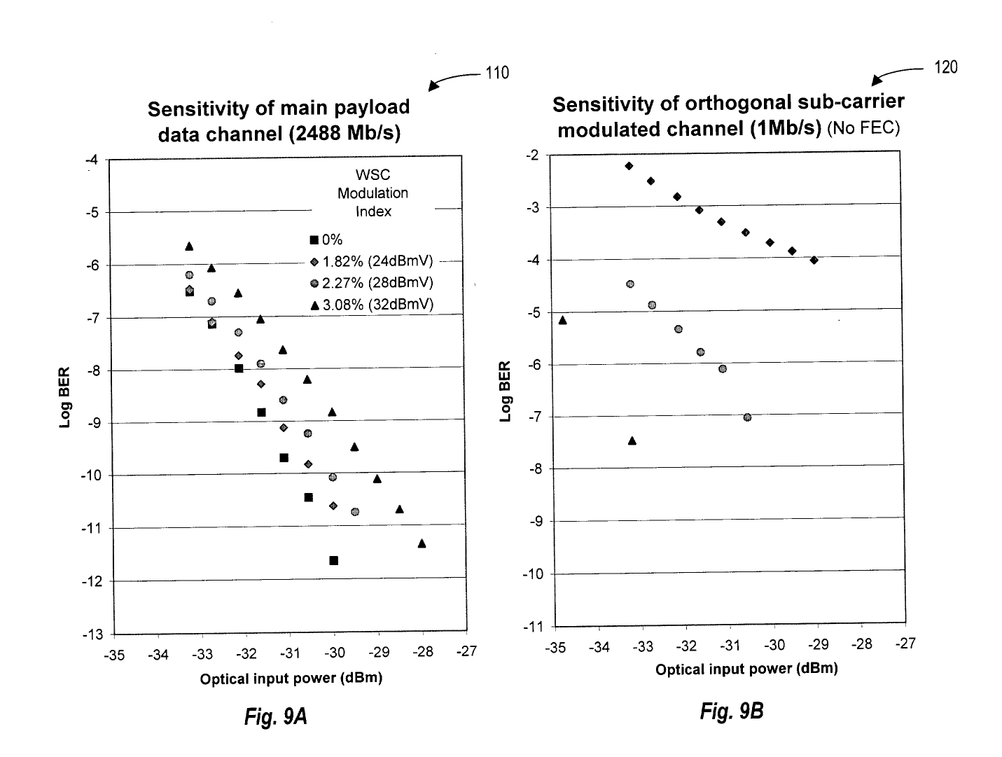

The above invention was built and the performance was measured and tested. FIG. 9A, indicated generally by 110, illustrates the measurement of the receiver sensitivity of the main payload data channel operating at the SONET OC-48 rate of 2.488 Mb/s with a 5 MHz, QPSK modulated WSC sub-carrier transmitting an 1 Mb/s data stream, under the following modulation indices: 0%, 1.82%, 27%, and 3.08%. Very little main channel receiver sensitivity penalty is seen from the illustration FIG. 9B, indicated generally by 120, illustrates the measurement of the receiver sensitivity of the sub-carrier receiver under the said operating conditions. As the illustration shows, a fully functional WSC channel can be obtained at a modulation index between 2-3%. With the FEC enabied, a fully functional WSC channel can be obtained at an even low(.r modulation index, enabling an unobtrusive communication channel.

### Conclusion, Ramifications and Scope

Accordingly, the invention described above enables the deployment of low cost wavelength supervisory channels on existing single and multi-wavelength optical (communications systems that are now being used in short haul metro networks, CATV fiber-coax hybrid systems, Metropolitan Area Networks and in some cases even in inter-campus Local Area Networks. It promises to dramatically reduce the cost of deployment, operation, management, provisioning and switching of such systems with a graceful and pay-as-you-grow means of increasing the management messaging capacity by using low cost, all electronic method of transmission and receipt of said supervisory channels.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A method of increasing the signal-to-noise ratio (SNR) of an orthogonal sub-carrier multiplexed communication channel that rides along with thee main payload data channel in a single or multi-wavelength optical communication system comprising:
a. a direct current (DC) bias, current port of the laser diode in said optical communication system configured to modulate said laser with the formatted and up-converted sub-carrier signal
b. an electronic circuit configured so that the modulation of said sub-carrier tracks the changes in laser bias current due to temperature and ageing thereby maintaining a constant modulation index over the operating temperature and lifetime of said laser
c. a trans-impedance amplifier coupled to the low impedance node of the photo-detector in said optical communication system and configured to block the dissipation of the detected sub-carrier photo-current by using a tuned resonant circuit thereby recovering said sub-carrier signal
d. a means of incorporating forward error correction coding and decoding in said sub-carrier transmitter and receiver respectively thereby enhancing the robustness of said sub-carrier transmission channel
e. a means of using modulation formats such as phase-shift-keyed (PSK), quadrature m-phase-shift-keyed (QPSK), differential quadrature phase-shift-keyed (DQPSK), m-phase-shift-keyed (m-PSK), m-quadrature amplitude modulation (m-QAM) to modulate said sub-carrier signal.

2. A method of claim 1, including means of carrier recovery at the receiver of said sub-carrier comprising:
a. a means of using locally generated clock at the transmitter to generate sub-carrier
b. a means of using locally generated clock at the receiver to re-generate the sub-carrier with any frequency offset between said generated and said re-generated carrier frequency removed by digital or analog signal processing in the receiver demodulator.

3. A method of claim 1, including means of carrier recovery at the receiver of said sub-carrier comprising:
a. a means of using the clock source of said main payload data channel to synchronously generate said sub carrier at the transmitter
b. a means of using the recovered clock of said main payload data channel to synchronously re-generate the sub-carrier at the receiver.

4. A method of claim 1, including means of increasing the fault tolerance, reliability and robustness of said sub-carrier channel comprising:
a. a means of providing a plurality of sub-carrier channels modulated on a plurality of wavelengths on the same fiber in said multi-wavelength optical communication system
b. a means of providing one of said plurality of sub-carrier channels as a backup channel in case of failure of said sub-carrier channel.

5. A method of claim 1, including means of identifying each wavelength in the said multi-wavelength optical communications system comprising:
a. a means of uniquely assigning sub-carrier frequency to wavelength according to a predefined frequency plan
b. a means of transmitting said assigned sub-carrier frequency on the transmitter on the assignee wavelength
c. a means of receiving the sub-carrier frequency at the receiver, and
d. a means of detecting the frequency and hence the assigned wavelength.

6. A method of claim 1, including means of providing a graceful, pay-as-you-grow, method of upgrading the transmission of control and management messages as tile network grows comprising:
a. a means of adding said sub-carrier channels that carry control and management messages as wavelengths are added to said multi-wavelength optical communication system.
